(19) United States
(12) Patent Application Publication
(10) Pub. No.: US 2025/0166509 A1
(43) Pub. Date: May 22, 2025

(54) IMPACT PREVENTION SYSTEM AND METHOD FOR VEHICLE

(71) Applicant: HYUNDAI MOBIS CO., LTD., Seoul (KR)

(72) Inventor: Chan Gill CHOI, Hwaseong-si (KR)

(73) Assignee: HYUNDAI MOBIS CO., LTD., Seoul (KR)

(21) Appl. No.: 18/822,695

(22) Filed: Sep. 3, 2024

(30) Foreign Application Priority Data
Nov. 22, 2023 (KR) 10-2023-0163039
Apr. 4, 2024 (KR) 10-2024-0045773

(51) Int. Cl. G08G 1/16; H04N 7/18; H04N 23/61

(52) U.S. Cl. CPC G08G 1/166; H04N 7/188; H04N 23/61

(57) ABSTRACT

An impact prevention system, an impact prevention method, and an impact prevention system for a vehicle, are provided. The impact prevention system includes: an ultrasonic sensor configured to detect an object around a vehicle; a camera to take one or more images of surroundings of the vehicle; a warning device to output a warning signal; a communicator to communicate with a user terminal of the vehicle; and a processor to control the camera to take an image of the surroundings of the vehicle in response to the ultrasonic sensor detecting an approach of the object with respect to the vehicle, control the warning device to output the warning signal corresponding to a level of the approach of the object, and control the communicator to transmit an indication that an event, corresponding to an activation of the warning device, to the user terminal, in response to each occurrence of the event.

### CROSS-REFERENCE TO RELATED APPLICATION(S)

The present application claims the benefit under 35 USC § 119 of Korean Patent Application No. 10-2023-0163039 filed on Nov. 22, 2023 and Korean Patent Application No. 10-2024-0045773 filed on Apr. 4, 2024, in the Korean Intellectual Property Office, the entire disclosures of which are incorporated herein by reference for all purposes.

### BACKGROUND

### 1. Field

The present disclosure relates to an impact prevention system and an impact prevention method for a vehicle.

### 2. Description of the Related Art

The content described in this section simply provides background information for the present disclosure and does not constitute related art.

A phenomenon in which a door of a parked vehicle collides with a door of another adjacent vehicle is called a door ding (or dinging a car door). The main cause of the door ding is a lack of space between the door of a parked vehicle and the door of another vehicle. The door ding causes the appearance of vehicles and the aesthetics of vehicles to deteriorate.

To prevent the door ding, door ding prevention stickers may be used, but the reality is that door ding prevention stickers have poor aesthetics and are insufficient as a warning signal to prevent the door ding. It may be possible to monitor behaviors that may damage the exterior of vehicles, such as a door ding, by using a black box installed in vehicles, but there is no advance warning system that may effectively prevent a door ding.

A system that may be mounted in a parked vehicle to prevent the parked vehicle from getting a door ding and warn objects around the parked vehicle, when a specific object, such as a human, another vehicle, or an animal, approaches the parked vehicle or opens the door of another vehicle located on the side of the parked vehicle, is required. In addition, a system that may warn people to prevent a specific object from applying an impact on parked vehicles or damaging parked vehicles is required.

### SUMMARY

In view of the above, the present disclosure is to output a warning signal for an object that approaches a vehicle and prevent events, such as a door ding, which is a phenomenon in which a door of a parked vehicle collides with a door of an adjacent vehicle, by the warning signal.

The present disclosure provides a method of warning an object around a vehicle in order to prevent events, such as an impact applied to a parked vehicle by an object or damage to the vehicle.

The present disclosure also provides a method for collecting information on an object that causes an event.

The present disclosure is to immediately notify a user of a vehicle of the occurrence of an event when the event occurs.

The problems to be solved by the present disclosure are not limited to the problems mentioned above, and other problems not mentioned may be clearly understood by those skilled in the art from the description below.

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In a general aspect of the disclosure, an impact prevention system includes: an ultrasonic sensor configured to detect an object around a vehicle; a camera configured to take one or more images of surroundings of the vehicle; a warning device configured to output a warning signal; a communicator configured to communicate with a user terminal of the vehicle; and a processor configured to: control the camera to take an image of the surroundings of the vehicle in response to the ultrasonic sensor detecting an approach of the object with respect to the vehicle; control the warning device to output the warning signal corresponding to a level of the approach of the object; and control the communicator to transmit an indication that an event, corresponding to an activation of the warning device, to the user terminal, in response to each occurrence of the event.

The warning device may include a speaker configured to output a warning sound corresponding to a level of approach of the object.

The warning device may include a display displaying a visual warning corresponding to a level of approach of the object on an outer surface of the vehicle.

The display may be integrated with a window of the vehicle.

The warning device may include a lamp and a puddle lamp configured to emit light to issue a warning corresponding to the level of approach of the object.

The impact prevention system may further include a memory, wherein, in response to the occurrence of the event, the processor may be further configured to store an image captured by the camera in the memory.

In response to the event being caused by the object, the processor may be further configured to control the camera to take an image of the object.

In response to another vehicle causing the event, the processor may be further configured to control the camera to take an image of a license plate number of the other vehicle.

The processor may be further configured to control the communicator to transmit information related to the object to the user terminal.

In another general aspect of the disclosure, an impact prevention method includes: detecting an object around a vehicle; imaging surroundings of the vehicle and outputting a warning signal, in response to an approach of the object with respect to the vehicle being detected; and transmitting, in response to an event, corresponding to the outputting of the warning signal, has occurred, to the vehicle, an indication that the event has occurred to a terminal of the vehicle.

The outputting of the warning signal may include outputting a warning sound and displaying a visual warning on a window of the vehicle.

The outputting of the warning signal may include emitting light using a lamp and a puddle lamp.

The outputting of the warning signal may include outputting a warning signal corresponding to a level of approach of the object.

In yet another general aspect of the disclosure, an impact prevention system for a vehicle, includes: a sensor to detect one or more objects approaching the vehicle; one or more cameras positioned on the vehicle to take one or more images of surroundings of the vehicle; an alarm configured to output a warning signal; a user terminal for displaying visual information; a transceiver configured to communicate with the user terminal of the vehicle; and a processor configured to: receive an indication from the sensor of the detection of the one or more objects approaching the vehicle; control the camera to take one or more images of the surroundings of the vehicle, in response to the sensor detecting the approach of the one or more objects with respect to the vehicle; control the alarm to output the warning signal corresponding to a predetermined level corresponding to the approach of the one or more objects; and control the transceiver to transmit an indication that an event, corresponding to an activation of the alarm, to the user terminal.

The alarm may include at least one of: a speaker configured to output a warning sound corresponding to a level of the approach of the one or more objects; a display integrated with a window of the vehicle for displaying a visual warning corresponding to the level of the approach of the one or more objects toward an outer surface of the vehicle; a lamp to emit light to issue a warning corresponding to the level of the approach of the one or more objects; or any combination thereof.

The sensor may include at least one of an ultrasonic sensor, a radar sensor, a light detection and ranging (lidar) sensor, an image sensor, or any combination thereof.

In response to the event being caused by the one or more objects, the processor may be further configured to control the one or more cameras to capture one or more images of the one or more objects.

In response to another vehicle causing the event, the processor may be further configured to control the one or more cameras to capture an image of at least one of a license plate of the other vehicle, a driver of the other vehicle, a passenger in the other vehicle, or any combination thereof.

The processor may be further configured to control the transceiver to transmit information related to the one or more objects to the user terminal.

### BRIEF DESCRIPTION OF THE DRAWINGS

FIG. 1 is a functional block diagram of an impact prevention system according to an embodiment of the present disclosure.

FIG. 2 is a diagram illustrating a sensor unit and a warning unit according to an embodiment of the present disclosure.

FIG. 3 is a diagram illustrating a warning signal according to an embodiment of the present disclosure.

FIG. 4 is a flowchart illustrating an impact prevention method according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

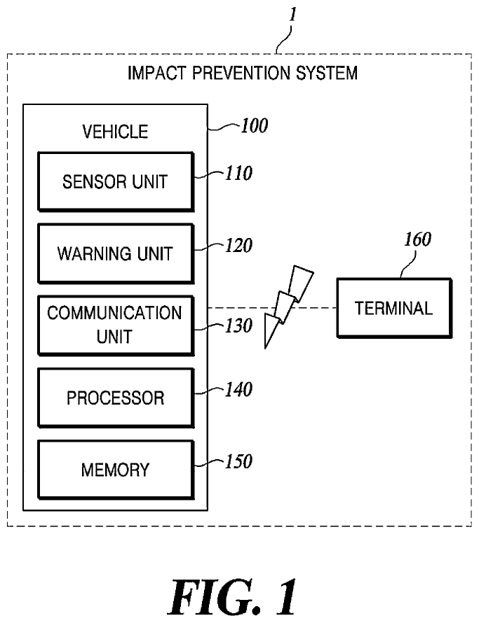

FIG. 1 is a functional block diagram of an impact prevention system according to an embodiment of the present disclosure.

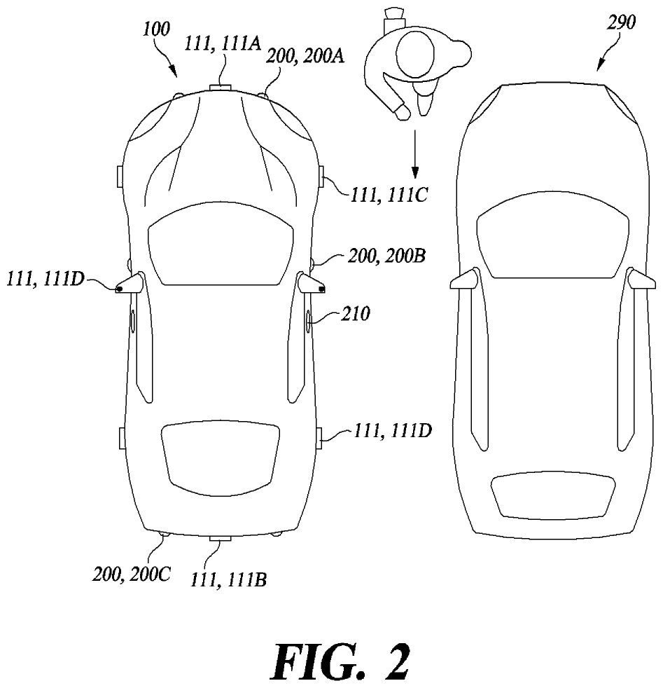

FIG. 2 is a diagram illustrating a sensor unit and a warning unit according to an embodiment of the present disclosure.

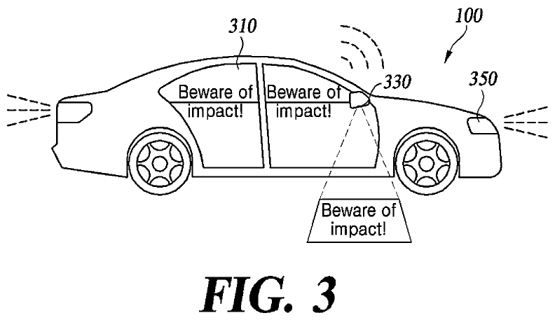

FIG. 3 is a diagram illustrating a warning signal according to an embodiment of the present disclosure.

Referring to FIGS. 1 to 3, an impact prevention system 1 may detect approach of an object toward a vehicle 100. In this specification, the object may be a human, another vehicle 290, a living being, etc.

The impact prevention system 1 may monitor whether an event occurs.

In this specification, an event refers to any case in which impact and/or damage occurs to the vehicle 100 due to an external force. An event is considered to have occurred if impact and/or damage occurs to any part of the vehicle, including a vehicle door, a vehicle side mirror, a vehicle roof, a vehicle windshield, a vehicle trunk, and a vehicle wheel. For example, the event includes a case in which an object approaches the parked vehicle 100 and contact occurs between the vehicle 100 and the object or a case in which an impact occurs on the vehicle 100 due to physical contact with the object. For example, the event includes a case in which, while a door of another vehicle 290 (FIG. 2) is being opened, the door of the other vehicle 190 impacts the door of the parked vehicle 100 (i.e., dings a car door). For example, an event includes all cases in which a specific object touches or impacts the vehicle 100.

When the impact prevention system 1 detects an object around the vehicle 100, the impact prevention system 1 may image the surroundings of the vehicle.

The impact prevention system 1 may output a warning signal to prevent an event from occurring. For example, when an object approaches the vehicle 100, the impact prevention system 1 may output a warning signal.

When an event occurs, the impact prevention system 1 may communicate with a vehicle user's terminal 160 to notify the vehicle user of the fact that the event has occurred.

When an event occurs, the impact prevention system 1 may store information on the object obtained by imaging in a memory 150 and transmit information on the object to the terminal 160.

The impact prevention system 1 includes all or some of a sensor unit 110, a warning unit 120, a communication unit 130, a processor 140, and the memory 150.

The sensor unit 110 may detect the approach of an object to the vehicle 100 using an ultrasonic sensor 200 and/or a camera 111 and monitor whether an event occurs.

The sensor unit 110 may include the ultrasonic sensor 200. The ultrasonic sensor 200 may be configured to detect objects around the vehicle 100. For example, the ultrasonic sensor 200 may detect humans, animals, other vehicles 290, etc. present around the vehicle 100. The ultrasonic sensor 200 may detect the degree of approach of an object to the vehicle 100. The ultrasonic sensor unit 110 may be substituted with or supplemented with various other sensors, e.g., a radar sensor, a light detection and ranging (lidar) sensor, an image sensor, or any combination thereof.

The ultrasonic sensor 200 may be placed in various positions 200A to 200C (see FIG. 2) of the vehicle 100, such as the front, rear, left, and right sides of the vehicle 100. The number, shape, and position of the ultrasonic sensors 200 shown in the drawings are an example, and the number, shape, and position of the ultrasonic sensors 200 are not limited by the drawings.

The sensor unit 110 may include the camera 111. The camera 111 may be configured to image the surroundings of the vehicle 100. According to an embodiment, the cameras 111 may be of the same or different types and may be placed in various positions of the vehicle 100. For example, a front camera 111A, a rear camera 111B, a front-side camera 111C, a rear-side camera 111D, etc. may be disposed. The number, shape, and position of the cameras 111 illustrated in the drawing are an example, and the shape and position of the camera 111 are not limited by the disclosure of the drawing.

The front camera 111A and the rear camera 111B may image the front and rear of the vehicle 100, respectively. The front-side camera 111C may be configured to image the front of the vehicle 100 and the side of the vehicle 100. The rear-side camera 111D may be configured to image the rear of the vehicle 100 and the side of the vehicle 100.

According to an embodiment, the camera 111 may detect the approach of an object. When an object approaches the vehicle 100, the camera 111 may image the object.

The camera 111 may image the moment when an event is caused by an object. For example, the camera 111 may image the moment when a human impacts the vehicle 100. For example, the camera 111 may image the moment when someone else impacts the door of the parked vehicle 100, while opening the door of the other vehicle 290.

According to an embodiment, the camera 111 may image the other vehicle 290 when an event is caused by the other vehicle 290. By imaging the other vehicle 290, the camera 111 may collect information on the other vehicle 290, such as the color of the other vehicle 290, the shape of the other vehicle 290, and the model of the other vehicle 290.

According to an embodiment, when an event is caused by the other vehicle 290, the camera 111 may capture the license plate number of the other vehicle 290.

After an event is caused by a human and/or the other vehicle 290, if the human and/or the other vehicle 290 runs away without contacting the user of the vehicle 100, the user of the vehicle 100 may identify the escaped human and/or the other vehicle 290 using information of the human, the information of the other vehicle 290, a vehicle number, and the like, acquired by imaging.

The sensor unit 110 may include an ultrasonic sensor that is already installed and used in the conventional vehicles. For example, the sensor unit 110 may include an ultrasonic sensor for detecting a parking distance provided in a bumper.

The sensor unit 110 may include a specially manufactured ultrasonic sensor whose sole purpose is to prevent impact to the vehicle 100.

The sensor unit 110 may include a camera that is already mounted and used in a conventional vehicle. For example, the sensor unit 110 may include the camera 111D attached to a side mirror.

The sensor unit 110 may include a specially manufactured camera 111 whose sole purpose is to prevent impacts to the vehicle 100.

That is, there is no limit to the ultrasonic sensor 200 and camera 111 that the sensor unit 110 may include.

The warning unit 120 may be configured to output a warning signal corresponding to a level of approach of the object. According to an embodiment, the level of approach of the object may be set based on a distance between the object and the vehicle 100. For example, as the distance between the vehicle 100 and the human decreases, the level of approach of the object is high. For example, as the distance between the vehicle 100 and the other vehicle 290 decreases, the level of approach of the object is high.

The level of approach of an object may change in real time. For example, when an object is approaching the parked vehicle 100, the level of approach of the object increases in real time.

The processor 140 determines the level of approach of the object and controls the warning unit 120 to output a warning signal corresponding to the level of approach of the object.

When determining the level of approach of an object, the processor 140 first rapidly determines the approach of an object using the ultrasonic sensor 200, and secondarily precisely calculates a type of object, a speed of approach of the object, a distance between the object and the vehicle 100, a level of approach of the object, and the like, by analyzing signals received from the ultrasonic sensor 200 and images by the camera 111.

The warning unit 120 may include a speaker 210. The speaker 210 may output a warning sound corresponding to the level of approach of the object. The shape and position of the speaker 210 shown in the drawing are an example, and the shape and position of the speaker 210 are not limited by the drawing.

The warning unit 120 may include a display 310. The display 310 may display a visual warning corresponding to the level of approach of the object on the front and/or side of the vehicle 100. According to an embodiment, the display 310 may be integrated with a front window and/or side window of the vehicle 100. In this case, the window may function as the display 310, and a visual warning may be displayed on the window. For example, the display 310 may display a visual warning using text, such as “Beware of impact,” “Beware of door ding,” etc. on the side window of the vehicle 100 (see FIG. 3). Unlike that illustrated in FIG. 3, the display 310 may be a display 310 installed separately from the window, rather than the display 310 integrated with the window. In this case, the display 310 may be attached to an outer surface of the vehicle 100.

The warning unit 120 may output a warning sound using a horn. As the level of approach of the object increases, the volume of the horn may increase.

The warning unit 120 may include a lamp 350 that outputs a warning signal using light. The lamp 350 may output a warning signal in a blinking manner. The lamp 350 may output a warning signal in response to the level of approach of the object. As the level of approach of the object increases, a blinking interval of the lamp 350 may become shorter or the light intensity of the lamp 350 may become stronger.

The warning unit 120 may include a puddle lamp 330 that outputs a warning signal using light. The puddle lamp 330 may output a warning signal by emitting light on a road surface. As shown in FIG. 3, the puddle lamp 330 may output characters, such as “Beware of impact!”, “Beware of door ding!” to the road surface. The puddle lamp 330 may output a warning signal in a blinking manner. The puddle lamp 330 may output a warning signal in response to the level of approach of the object. As the level of approach of the object increases, a blinking interval of the puddle lamp 330 may become shorter, the intensity of light of the puddle lamp 330 may become stronger, or the size of a character displayed by the puddle lamp 330 may become larger.

When the warning unit 120 detects an object approaching the vehicle 100, the warning unit 120 may output a first warning signal. For example, a sentence “Filming around the vehicle” may be output on the display 310 as the first warning signal. At the same time, as the first warning signal, a warning sound, such as “Filming around the vehicle” and/or “Please be careful not to impact the vehicle” may be output. The first warning signal is output when the distance between the vehicle 100 and the object is greater than or equal to a first threshold.

The warning unit 120 may output a second warning signal when the distance between the vehicle 100 and the object is less than the first threshold. For example, if the distance between the door of the vehicle 100 and the door of the other vehicle 290 is less than the first threshold, the warning unit 120 may output a warning sound, such as “There is a high possibility of collision with current vehicle. Please be careful” and/or “There is a high possibility of door ding. Please be careful” and display the same on the display 310. Alternatively, if an approach speed of the object to the vehicle 100 is equal to or higher than a preset speed, the warning unit 120 may output a second warning signal.

The warning unit 120 may output a third warning signal when an event occurs between the vehicle 100 and an object. For example, when an impact is applied to the door of the parked vehicle 100, while the door of the other vehicle 290 is opened, the warning unit 120 may output a warning sound, such as “Door ding occurred, please contact the owner” as the third warning signal, and display the same on the display 310. At the same time, the warning unit 120 may sound a siren as a warning sound.

The communication unit 130 may be configured to communicate with the terminal 160 of the user of the vehicle 100. When an event occurs in the vehicle 100, the communication unit 130 may transmit the fact that the event has occurred to the user's terminal 160.

An image captured by the camera 111 may be stored in the memory 150. According to an embodiment, the memory 150 may store the image captured by the camera 111 when an event occurs in the vehicle 100. If an event does not occur in the vehicle 100, the memory 150 may not store the image captured by the camera 111.

When the ultrasonic sensor 200 detects an object approaching the vehicle 100, the processor 140 may control the camera 111 to image the surroundings of the vehicle 100.

The processor 140 may control the warning unit 120 to output a warning signal corresponding to the level of approach of the object.

When an event occurs in the vehicle 100, the processor 140 may control the communication unit 130 to notify the user's terminal 160 of the occurrence of the event.

When an event occurs, the processor 140 may control the memory 150 to store the image captured by the camera 111.

If an event occurs due to the other vehicle 290, the processor 140 may control the camera 111 to image the other vehicle 290.

When an event is caused by the other vehicle 290, the processor 140 may control the camera 111 to capture the license plate number of the other vehicle 290. The cameral 111 may additionally capture the driver of the other vehicle, a passenger in the other vehicle, etc.

When an event is caused by the other vehicle 290, the processor 140 may control the communication unit 130 to transmit information on the other vehicle 290 to the user's terminal 160.

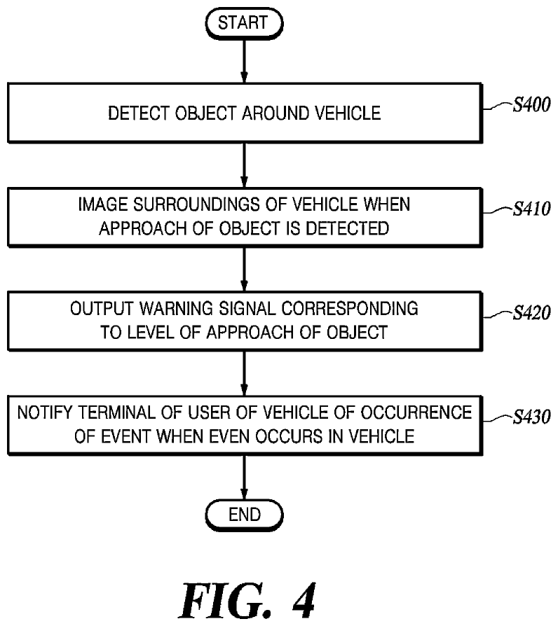

FIG. 4 is a flowchart illustrating an impact prevention method according to an embodiment of the present disclosure.

Referring to FIGS. 1 to 4, the impact prevention system 1 for a vehicle may detect an object around the vehicle (S400). Here, the object may be a human, the other vehicle 290, a living being, etc.

When the impact prevention system 1 for a vehicle detects the approach of an object to the vehicle 100, the impact prevention system 1 may image the surroundings of the vehicle 100 (S410). For example, when the approach of a human or the other vehicle toward the vehicle 100 is detected, the impact prevention system 1 may begin monitoring for the human or the other vehicle using ultrasonic sensor 200 and/or camera 111. The surroundings of the vehicle 100 may be imaged using the camera 111 to image a human and/or the other vehicle approaching the vehicle 100.

The impact prevention system 1 may output a warning signal corresponding to the level of approach of the object (S420). A warning signal that may alert an object approaching the vehicle 100 may be output. As the level of approach of the object is higher and as the approach speed of the object is faster, a high level warning signal may be output. The level of approach of an object increases as the object is closer to the vehicle 100.

The first warning signal may be output when the distance between the vehicle 100 and the object is greater than or equal to a first threshold. For example, a sentence “Please be careful not to impact the vehicle” may be output on the display 310 as the first warning signal. At the same time, as a first warning signal, a warning sound, such as “Filming around the vehicle” and/or “Please be careful not to impact the vehicle” may be output. At the same time, the impact prevention system 1 may issue a warning signal using light. For example, the lamp 350 may be flashed to warn the object (see FIG. 3). For example, the impact prevention system 1 may output text, such as “Beware of Impact” on the road surface using the puddle lamp 330 of the vehicle 100. The impact prevention system 1 may adjust the intensity of light of the lamp 350 and/or the puddle lamp 330 to be stronger as the level of approach of the object is higher. The impact prevention system 1 may sound the horn to warn the object. The impact prevention system 1 may increase the volume of the horn sound as the level of approach of the object is higher.

In this manner, the impact prevention system 1 causes the object to recognize the warning signal more effectively using at least one or more of a warning using light, a visual warning using text, and a warning sound together, and prevent impact or damage to the vehicle 100.

The impact prevention system 1 may output a second warning signal when the distance between the vehicle 100 and the object is less than the first threshold. As the second warning signal, a warning sound, such as “There is a high possibility that an impact will occur in the current vehicle. Please be careful” may be output and displayed on the display 310. As the second warning signal, the light intensity of the lamp 350 and the puddle lamp 330 may be adjusted to be brighter and the horn sound may be output louder than in the case of the first warning signal. As the object is closer to the vehicle 100, the lamp 350 and the puddle lamp 330 may blink faster to provide a higher alert to the object.

As another example, assuming a situation in which the other vehicle 290 is parked next to the parked vehicle 100 and a door ding is likely to occur, a sentence “Filming door ding” may be output on the display 310. At the same time, as the first warning signal, a warning sound, such as “Filming door ding” and/or “Please be careful of door ding” may be output. The first warning signal is output when the distance between the vehicle 100 and the object is greater than or equal to the first threshold. The impact prevention system 1 may output a second warning signal when the distance between the vehicle 100 and the object is less than the first threshold. For example, if the distance between the door of the vehicle 100 and the door of the other vehicle 290 is less than the first threshold, the impact prevention system 1 may output a warning sound, such as “There is a high possibility of door ding currently. Please be careful” as the second warning signal and display the same on the display 310. The second warning signal may be output even when a relative speed of the door of the other vehicle 290 approaching the door of the vehicle 100 is greater than or equal to a preset speed. The display 310 may be integrated with the window, and a visual warning signal may be displayed on the window.

When an event occurs in the vehicle 100, the impact prevention system 1 may notify the terminal 160 of the user of the vehicle 100 of the occurrence of the event (S430). Specifically, the impact prevention system 1 may transmit the fact that an event has occurred to the user terminal 160 of the vehicle 100 using the communication unit 130. When an event occurs, the user of the vehicle 100 may immediately recognize the fact that the event has occurred through the terminal 160 and may immediately respond to the event.

When an event occurs, the impact prevention system 1 may store an image captured by the camera 111 in the memory 150.

The impact prevention system 1 may output a third warning signal when an event occurs. For example, when a walking person impacts the side mirror of the parked vehicle 100, the impact prevention system 1 may output a warning sound, such as “Impact occurred with the vehicle, please contact the vehicle owner”, as the third warning signal, display the same on the display 310. At the same time, the lamp 350 of the vehicle may blink. At the same time, it is also possible to provide a visual warning on the road surface using the puddle lamp 330.

For example, when an impact is applied to the door of the parked vehicle 100, while the door of the other vehicle 290 is open, the impact prevention system 1 may output a warning sound, such as “Door ding occurred, please contact the vehicle owner” as the third warning signal may display the same on the display 310. At the same time, the impact prevention system 1 may sound a siren as a warning sound.

The impact prevention system 1 may capture the moment an event occurs. For example, the camera 111 may capture the moment when someone else impacts the door of the parked vehicle 100, while opening the door of the other vehicle 290. According to an embodiment, the impact prevention system 1 may image the other vehicle 290 when an event occurs due to the other vehicle 290. That is, the impact prevention system 1 may image the other vehicle 290 and collect information of the other vehicle 290, including the color of the other vehicle 290, the shape of the other vehicle 290, and the model of the other vehicle 290. The impact prevention system 1 may image a human when an event occurs due to a human. For example, the camera 111 may capture the moment when a human impacts the side mirror of the vehicle 100.

According to an embodiment, when an event is caused by the other vehicle 290, the impact prevention system 1 may image the license plate number of the other vehicle 290.

According to an embodiment, when an event is caused by a human, the impact prevention system 1 may image the human who caused the event to collect information on the features, clothes, etc.

In the above, the first warning signal, second warning signal, and third warning signal have been described as warning signals, but this is only an example for description, and the level of the warning signal is not limited to the three steps of first level, second level, and third level. The level of approach of an object and the level of warning signals may be further divided.

According to another embodiment, when an object is detected around the vehicle 100, the impact prevention system 1 may image the surroundings of the vehicle 100 and simultaneously output a warning signal. At this time, the process of outputting a warning signal may be a process of using at least one of a warning using light, a visual warning using text, and a warning sound. That is, in another embodiment, a warning signal may be output when an object is detected around the vehicle 100 regardless of the level of approach of the object. In this case, since a warning signal is output regardless of whether the object is closer to the vehicle 100, the vehicle 100 may be more safely protected from the object.

When an event occurs in the vehicle 100, the impact prevention system 1 according to another embodiment may transmit the fact that an event has occurred to the terminal 160 of the user of the vehicle 100.

In addition, various elements, such as the sensor unit 110 (e.g., sensor), the warning unit 120 (e.g., warning device or alarm), and the communication unit 130 (e.g., communicator or transceiver), may be identified differently, as noted above.

Each component of the device or method according to the present disclosure may be implemented as hardware or software or may be implemented as a combination of hardware and software. In addition, the function of each component may be implemented as software and a microprocessor may be implemented to execute the function of the software corresponding to each component.

Various implementations of systems and techniques described herein may be realized as digital electronic circuits, integrated circuits, field programmable gate arrays (FPGAs), application specific integrated circuits (ASICs), computer hardware, firmware, software, and/or combinations thereof. These various implementations may include one or more computer programs executable on a programmable system. The programmable system includes at least one programmable processor (which may be a special-purpose processor or a general-purpose processor) coupled to receive and transmit data and instructions from and to a storage system, at least one input device, and at least one output device. The computer programs (also known as programs, software, software applications or codes) contain commands for a programmable processor and are stored in a “computer-readable recording medium”.

The computer-readable recording medium includes all types of recording devices in which data readable by a computer system is stored. Such a computer-readable recording medium may be a non-volatile or non-transitory medium, such as ROM, CD-ROM, magnetic tape, floppy disk, memory card, hard disk, magneto-optical disk, or a storage device, and may further include a transitory medium such as a data transmission medium. In addition, the computer-readable recording medium may be distributed in a computer system connected via a network, so that computer-readable codes may be stored and executed in a distributed manner.

Various implementations of systems and techniques described herein may be embodied by a programmable computer. Here, the computer includes a programmable processor, a data storage system (including volatile memory, non-volatile memory, or other types of storage systems, or combinations thereof) and at least one communication interface. For example, the programmable computer may be one of a server, a network device, a set top box, an embedded device, a computer expansion module, a personal computer, a laptop, a personal data assistant (PDA), a cloud computing system, or a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An impact prevention system comprising:
an ultrasonic sensor configured to detect an object around a vehicle;
a camera configured to take one or more images of surroundings of the vehicle;
a warning device configured to output a warning signal;
a communicator configured to communicate with a user terminal of the vehicle; and
a processor configured to:
control the camera to take an image of the surroundings of the vehicle in response to the ultrasonic sensor detecting an approach of the object with respect to the vehicle;
control the warning device to output the warning signal corresponding to a level of the approach of the object; and
control the communicator to transmit an indication that an event, corresponding to an activation of the warning device, to the user terminal, in response to each occurrence of the event.

2. The impact prevention system of claim 1, wherein the warning device includes a speaker configured to output a warning sound corresponding to a level of approach of the object.

3. The impact prevention system of claim 1, wherein the warning device includes a display displaying a visual warning corresponding to a level of approach of the object on an outer surface of the vehicle.

4. The impact prevention system of claim 3, wherein the display is integrated with a window of the vehicle.

5. The impact prevention system of claim 1, wherein the warning device includes a lamp and a puddle lamp configured to emit light to issue a warning corresponding to the level of approach of the object.

6. The impact prevention system of claim 1, further comprising:
a memory,
wherein, in response to the occurrence of the event, the processor is further configured to store an image captured by the camera in the memory.

7. The impact prevention system of claim 1, wherein, in response to the event being caused by the object, the processor is further configured to control the camera to take an image of the object.

8. The impact prevention system of claim 7, wherein, in response to another vehicle causing the event, the processor is further configured to control the camera to take an image of a license plate number of the other vehicle.

9. The impact prevention system of claim 7, wherein the processor is further configured to control the communicator to transmit information related to the object to the user terminal.

10. An impact prevention method comprising:
detecting an object around a vehicle;
imaging surroundings of the vehicle and outputting a warning signal, in response to an approach of the object with respect to the vehicle being detected; and
transmitting, in response to an event, corresponding to the outputting of the warning signal, has occurred, to the vehicle, an indication that the event has occurred to a terminal of the vehicle.

11. The impact prevention method of claim 10, wherein the outputting of the warning signal includes outputting a warning sound and displaying a visual warning on a window of the vehicle.

12. The impact prevention method of claim 10, wherein the outputting of the warning signal includes emitting light using a lamp and a puddle lamp.

13. The impact prevention method of claim 10, wherein the outputting of the warning signal includes outputting a warning signal corresponding to a level of approach of the object.

14. An impact prevention system for a vehicle, the system comprising:
a sensor to detect one or more objects approaching the vehicle;
one or more cameras positioned on the vehicle to take one or more images of surroundings of the vehicle;
an alarm configured to output a warning signal;
a user terminal for displaying visual information;
a transceiver configured to communicate with the user terminal of the vehicle; and
a processor configured to:
receive an indication from the sensor of the detection of the one or more objects approaching the vehicle;
control the camera to take one or more images of the surroundings of the vehicle, in response to the sensor detecting the approach of the one or more objects with respect to the vehicle;
control the alarm to output the warning signal corresponding to a predetermined level corresponding to the approach of the one or more objects; and
control the transceiver to transmit an indication that an event, corresponding to an activation of the alarm, to the user terminal.

15. The system of claim 14, wherein the alarm includes at least one of:
a speaker configured to output a warning sound corresponding to a level of the approach of the one or more objects;
a display integrated with a window of the vehicle for displaying a visual warning corresponding to the level of the approach of the one or more objects toward an outer surface of the vehicle;
a lamp to emit light to issue a warning corresponding to the level of the approach of the one or more objects; or
any combination thereof.

16. The system of claim 14, wherein the sensor comprises at least one of an ultrasonic sensor, a radar sensor, a light detection and ranging (lidar) sensor, an image sensor, or any combination thereof.

17. The system of claim 14, wherein, in response to the event being caused by the one or more objects, the processor is further configured to control the one or more cameras to capture one or more images of the one or more objects.

18. The system of claim 14, wherein, in response to another vehicle causing the event, the processor is further configured to control the one or more cameras to capture an image of at least one of a license plate of the other vehicle, a driver of the other vehicle, a passenger in the other vehicle, or any combination thereof.

19. The system of claim 14, wherein the processor is further configured to control the transceiver to transmit information related to the one or more objects to the user terminal.
